(19) United States
(12) Patent Application Publication
(10) Pub. No.: US 2025/0208633 A1
(43) Pub. Date: Jun. 26, 2025

(54) MAPPING OF OFF-ROAD AREA

(71) Applicant: Volvo Autonomous Solutions AB, Göteborg (SE)

(72) Inventors: Calle SKILLSÄTER, Torshälla (SE); Johan Sjöberg, Västerås (SE); Helena Götlind, Hindås (SE)

(73) Assignee: Volvo Autonomous Solutions AB, Göteborg (SE)

(21) Appl. No.: 18/969,871

(22) Filed: Dec. 5, 2024

(30) Foreign Application Priority Data
Dec. 22, 2023 (EP) 23219997.6

(51) Int. Cl. G05D 1/692; E02F 9/20; G05D 1/246; G05D 1/622; G05D 1/644; G05D 1/667; G05D 107/70; G07C 5/04

(52) U.S. Cl. CPC G05D 1/692; G05D 1/246; G05D 1/622; G05D 1/644; G05D 1/667; G07C 5/04; E02F 9/2045; G05D 2107/70

(57) ABSTRACT

A computer system comprising processing circuitry is presented. The processing circuitry is configured to obtain vehicle data of a specific vehicle and obtain map data of a confined off-road area. The processing circuitry is further configured to determine drivable area data for the specific vehicle within the confined off-road area based on the vehicle data and the map data; and provide the drivable area data for routing of the specific vehicle within the confined off-road area.

### TECHNICAL FIELD

The disclosure relates generally to routing planning. In particular aspects, the disclosure relates to off-road routing. The disclosure can be applied to heavy-duty vehicles, such as construction equipment and trucks among other vehicle types. Although the disclosure may be described with respect to a particular vehicle, the disclosure is not restricted to any particular vehicle.

### BACKGROUND

All vehicle requires routing to be safely operated. Generally, an operator of the vehicle surveils a surrounding area and controls the vehicle to avoid obstacles. Autonomous machines generally require routes that are pre-recorded or computed on the fly using, for instance, optimal control or similar methods.

In quarries and other very muddy conditions, the routing is challenging due to puddles, wheel tracks or other obstacles appearing almost randomly. Even manually operated vehicles are at risk of getting stuck in puddles if the puddle appears shallower than it is.

Having an autonomous or manually operated vehicle get stuck or damaged in an off-road area may cause costly downtime and the stuck or damaged vehicle may present an obstacle in itself preventing further work in the area.

### SUMMARY

According to a first aspect of the disclosure, a computer system comprising processing circuitry is presented. The processing circuitry is configured to: obtain vehicle data of a specific vehicle; obtain map data of a confined off-road area; determine drivable area data for the specific vehicle within the confined off-road area based on the vehicle data and the map data; and provide the drivable area data for routing of the specific vehicle within the confined off-road area. The first aspect of the disclosure may seek to reduce a risk of downtime within a confined off-road due to vehicles getting stuck, damaged or requiring maintenance. A technical benefit may include increasing the efficiency of operation within the confined off-road area.

Optionally in some examples, including in at least one preferred example, the processing circuitry is further configured to: obtain mission data for the specific vehicle, the mission data comprising an indication of a loading location and/or an unloading location within the confined off road area; determine one or more permitted routing trajectories for the specific vehicle to travel to/from the loading location and/or an unloading location based on the drivable area data and the mission data; and select one of the one or more permitted routing trajectories as a routing trajectory for routing of the specific vehicle. A technical benefit may include allowing to optimize a trajectory for a specific mission.

Optionally in some examples, including in at least one preferred example, the processing circuitry is configured to: select the routing trajectory based on an energy consumption indicator and/or a vehicle component wear indicator for the specific vehicle to complete the permitted routing trajectories. A technical benefit may include decreased cost of the mission.

Optionally in some examples, including in at least one preferred example, the mission data further comprises load weight data indicating a weight of goods to be loaded at the loading location and/or unloaded at the unloading location. A technical benefit may include considering also the weight when planning the mission potentially decreasing cost of the mission.

Optionally in some examples, including in at least one preferred example, the vehicle data comprises weight data for the specific vehicle, the map data comprises surface condition data for the confined off-road area, and the processing circuitry is further configured to: determine the drivable area data based on the weight data and the surface condition data. A technical benefit may include considering also the weight in combination with surface conditions when planning the mission potentially further decreasing cost of the mission.

Optionally in some examples, including in at least one preferred example, the vehicle data further comprises a traction capability of the specific vehicle, the map data comprises obstacle data indicating one or more obstacles of the confined off-road data, and the processing circuitry is further configured to: determine the drivable area data further based on the obstacle data and the traction capability of the specific vehicle. A technical benefit may include avoiding impassable obstacles and ignoring traversable obstacles such that a risk of the specific vehicle getting stuck is reduced and unnecessary detours are also reduced.

Optionally in some examples, including in at least one preferred example, wherein the traction capability comprises one or more of a wheel base, a ground clearance, traction functionality or an available drive torque of the specific vehicle. A technical benefit may include avoiding impassable obstacles and ignoring traversable obstacles such that a risk of the specific vehicle getting stuck is reduced and unnecessary detours are also reduced.

Optionally in some examples, including in at least one preferred example, the processing circuitry is further configured to: obtain an indication of a proposed change of the map data; and determine proposed drivable area data for the specific vehicle within the confined off-road area based on the proposed updated map data; and provide the proposed drivable area data and the drivable area data as decision data for determining if the confined off-road area is to be modified in line with the proposed change of the map data or not. A technical benefit may include enabling simulation of changes in the map data to determine potential cost benefits of making changes to the confined off-road area.

Optionally in some examples, including in at least one preferred example, the map data comprises obstacle data indicating one or more obstacles of the confined off-road data and the proposed change of the map data comprises modification of at least one obstacle. A technical benefit may include enabling simulation of removal of obstacles from the confined off-road area and determine potential savings of doing so.

Optionally in some examples, including in at least one preferred example, the processing circuitry is further configured to: obtain mission data for the specific vehicle, the mission data comprising an indication of a loading location and/or an unloading location within the confined off road area; determine one or more permitted routing trajectories for the specific vehicle to travel to/from the loading location and/or an unloading location based on the drivable area data and the mission data; and select one of the one or more permitted routing trajectories as a routing trajectory for routing of the specific vehicle; wherein the processing circuitry is configured to: select the routing trajectory based on an energy consumption indicator and/or a vehicle component wear indicator for the specific vehicle to complete the permitted routing trajectories; wherein the mission data further comprises load weight data indicating a weight of goods to be loaded at the loading location and/or unloaded at the unloading location; wherein the vehicle data comprises weight data for the specific vehicle, the map data comprises surface condition data for the confined off-road area, and the processing circuitry is further configured to: determine the drivable area data based on the weight data and the surface condition data; wherein the processing circuitry is configured to: determine the permitted routing trajectories further based on a weigh profile for the specific vehicle for traveling to/from the loading location and/or the unloading location, wherein the weight profile is determined based on the weight data of the specific vehicle and the load weight data; wherein the vehicle data further comprises a traction capability of the specific vehicle, the map data comprises obstacle data indicating one or more obstacles of the confined off-road data, and the processing circuitry is further configured to: determine the drivable area data further based on the obstacle data and the traction capability of the specific vehicle; wherein the traction capability comprises one or more of a wheel base, a ground clearance, traction functionality or an available drive torque of the specific vehicle; wherein the processing circuitry is further configured to: obtain an indication of a proposed change of the map data; and determine proposed drivable area data for the specific vehicle within the confined off-road area based on the proposed updated map data; and provide the proposed drivable area data and the drivable area data as decision data for determining if the confined off-road area is to be modified in line with the proposed change of the map data or not; wherein the map data comprises obstacle data indicating one or more obstacles of the confined off-road data and the proposed change of the map data comprises modification of at least one obstacle; wherein the off-road area is a quarry or a mine. A technical benefit may include all the above mentioned technical benefits.

According to a second aspect of the disclosure, a site management system is presented. The site management system is for a confined off-road area and comprises the computer system of the first aspect. The second aspect of the disclosure may seek to reduce a risk of downtime within a confined off-road due to vehicles getting stuck, damaged or requiring maintenance. A technical benefit may include increasing the efficiency of operation within the confined off-road area.

According to a third aspect of the disclosure, a computer implemented method is presented. The method comprising: obtaining, by processing circuitry of a computer system, vehicle data of a specific vehicle; obtaining, by processing circuitry of the computer system, map data of a confined off-road area; determining, by processing circuitry of the computer system, drivable area data for the specific vehicle within the confined off-road area based on the vehicle data and the map data; and providing, by processing circuitry of the computer system, the drivable area data for routing of the specific vehicle within the confined off-road area. The third aspect of the disclosure may seek to reduce a risk of downtime within a confined off-road due to vehicles getting stuck, damaged or requiring maintenance. A technical benefit may include increasing the efficiency of operation within the confined off-road area.

According to a fourth aspect of the disclosure, a computer program product is presented. The computer program product comprising program code for performing, when executed by processing circuitry, the computer implemented method of the third aspect. The fourth aspect of the disclosure may seek to reduce a risk of downtime within a confined off-road due to vehicles getting stuck, damaged or requiring maintenance. A technical benefit may include increasing the efficiency of operation within the confined off-road area.

According to a fifth aspect of the disclosure, a non-transitory computer-readable storage medium is presented. The non-transitory computer-readable storage medium comprising instructions, which when executed by processing circuitry, cause the processing circuitry to perform the computer implemented method the third aspect. The fifth aspect of the disclosure may seek to reduce a risk of downtime within a confined off-road due to vehicles getting stuck, damaged or requiring maintenance. A technical benefit may include increasing the efficiency of operation within the confined off-road area.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplar perspective view of a confined off-road environment according to an example.

FIG. 2 is an exemplar partial perspective view of a confined off-road environment according to an example.

FIG. 3 is an exemplar schematic view of a computer system according to an example.

FIG. 4 is an exemplar block diagram of a computer system according to an example.

FIG. 5 is an exemplar system diagram of a drivable map area determiner according to an example.

FIG. 6 is an exemplar system diagram of a drivable map area determiner according to an example.

FIG. 7 is an exemplar schematic view of a computer system according to an example.

FIG. 8 is an exemplar block diagram of a method according to an example.

FIG. 9 is an exemplar schematic view of a computer program produce according to an example.

FIG. 10 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

As mentioned, routing of vehicles may be challenging and especially in off-road conditions where the terrain may change due to weather, excavation and/or other factors. In for instance a quarry, obstacles may occur due to rocks falling of transporting vehicles, water forming deep muddy puddles, or draught forming difficult to traverse tracks in the surface. What is consider an obstacle may differ depending in a type of vehicle, for instance a heavy, strong loader may easily traverse obstacles that are impassable to a transporting vehicle such as a general road truck. This means that a drivable area within the quarry will differ depending on the vehicle. This is important when mission planning within the quarry as not all vehicles may efficiently reach all location within the quarry. Assuming a specific loading location within a quarry where a loading vehicle is to load material onto various transporting vehicles. It may very well be that the loading location is only (efficiently) accessible by transporting vehicle in the form of a heavy duty dump truck and not by general road trucks. This will prevent all transporting vehicles from accessing the loading area and it may be more efficient to either change the loading area and/or to clear a path to the loading area to allow all suitable transporting vehicles to access the loading are.

The present disclosure provides map data of drivable areas within a confined off-road area for a specific vehicle. This enables e.g. site management systems to more efficiently route vehicles, plan missions and clear paths. This reduces a risk of downtime due to e.g. vehicles getting stuck or damaged by obstacles.

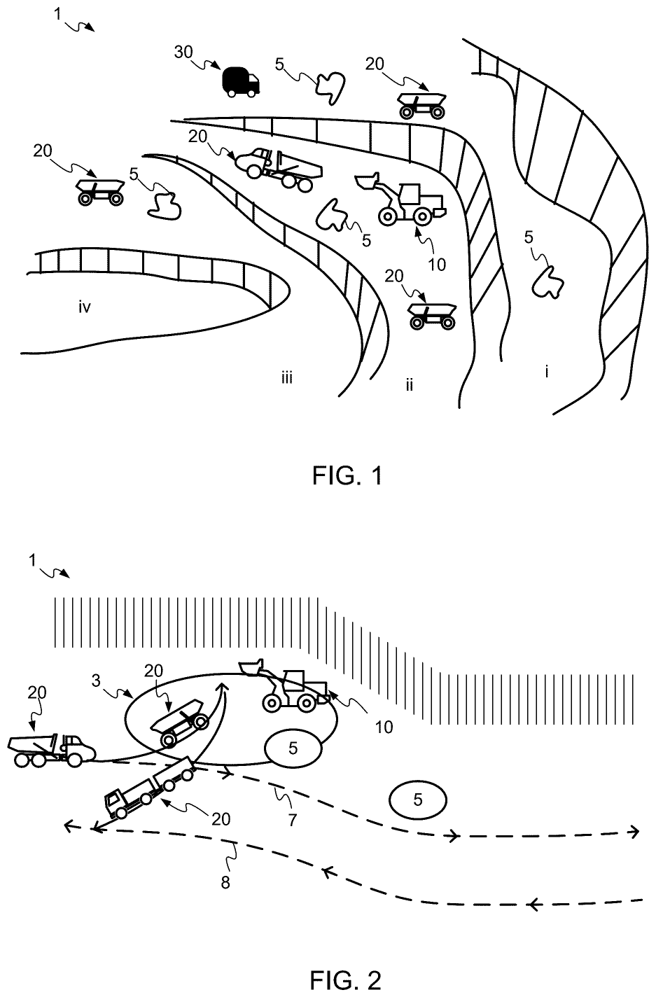

In FIG. 1, an exemplary confined off-road area 1 is shown. The confined off-road area 1 is a quarry, and this will be used to exemplify the teachings of the present disclosure. However, the present disclosure is in no way limited to confined off-road areas 1 in the form of quarries, but other confined off-road areas are will within the scope such as, but not limited to, areas of logging, mining etc. The confined off-road area 1 of FIG. 1 quarry comprising a first level i, a second level ii, a third level iii, and a fourth level iv, wherein the first level i is a top level and the fourth level iv is a bottom level. In the quarry, loaders 10 are operating to load material onto transporting vehicles 20. In FIG. 1, two types of transporting vehicles 20 are shown, an autonomous hauler and an operator controlled hauler. Other vehicles 30 may be present in the quarry such as trucks or other vehicles for transportation of personnel, light equipment etc. Scattered throughout the confined off-road area 1 are obstacles 5. The obstacles 5 may be puddles of mud, blocks of stone, wheel tracks, damaged or stuck vehicles etc. Any routing (manual or autonomous) of vehicles 10, 20, 30 within the confined off-road area 1 is advantageously configured to avoid the obstacles 5. To this end, map data of the confined off-road area 1 generally comprise locations of obstacles 5 within the confined off-road area 1.

Due to the volatile nature of the obstacles 5, obstacles 5 may change in nature, disappear och occur seemingly randomly within the confined off-road area 1. A sudden rain may create deep puddles and muddy roads that completely change the map data when it comes to obstacles. A few hours of sun may dry out a previously muddy road to create difficult (or impossible) to traverse wheel tracks. To this end, in some examples, obstacle data of the map data may be updated based on new obstacles 5, changed obstacles 5 and/or removed obstacles 5. In further examples, the map data is updated also based on features of the obstacles 5.

In FIG. 2, a partial view of a confined off-road area 1, a quarry, is shown. Although the blasting is controlled and performed under strict safety regulations, there is some randomness as to where the broken down material will land and how it will be arranged. In FIG. 2, an area where the material to be loaded onto transporting vehicles 20 is located in indicated as a loading area 3. The transporting vehicle 20 will enter the loading area 3 allowing the loading vehicle 10 to load material onto the transporting vehicle 20. Once sufficiently loaded, the transporting vehicle 20 exits the loading area 3 and transports the loaded material for e.g. further processing by a crusher which further reduces the size of the material.

Generally, the transporting vehicle 20 is configured with a longitudinal load carrying container for carrying the material. In order to efficiently load the load carrying container, the loading vehicle 10 may unload onto/into the load carrying container from a direction substantially perpendicular to a longitudinal extension of the load carrying container, this is generally the case when e.g. wheel loader unloads onto a transporting vehicle 20. The loading vehicle 10 may unload onto/into the load carrying container from a direction substantially along a direction along the longitudinal extension of the load carrying container (generally from the front or back of the transporting vehicle 20), this is generally the case when e.g. an excavator unloads onto a transporting vehicle 20. To this end, either the transporting vehicle 20 or the loading vehicle 10 is preferably arranged to allow efficient loading of the transporting vehicle 20. However, the loading vehicle 10 is advantageously able to efficiently access the material to be loaded onto the transporting vehicle 20 in order to reduce a time it takes to move each load of material onto the transporting vehicle 20. The transporting vehicle 20 should advantageously be able to efficiently enter and exit the loading area 3 at the location of the actual loading in order to reduce cycle time for the transporting vehicle 20.

In some examples, to e.g. increase safety at the confined off-road area 1, the transporting vehicles 20 may be restricted to travel along predetermined paths 7, 8. Generally, the paths 7, 8 are one-way such that an entry path 7 is defined for traveling to the loading area 3 and an exit path 8 is defined for traveling from the loading area 3. Regardless of the presence of entry and/or exit paths 7, 8 the transporting vehicle 20 will enter the loading area 3 at some specific direction and will exit the loading area at some specific direction. The entry and/or exit paths 7, 8 may limit a number of options for the transporting vehicle to enter/exit the loading area 3 and/or make some locations of the loading area 3 difficult (takes long time to access/exit) or impossible to access. The confined off-road area 1 and/or the loading area 3 may comprise one or more obstacles 5. As mentioned, the obstacles 5 may limit a number of options for the transporting vehicle 20 to enter/exit the loading area 3, and/or a number of locations for the loading vehicle 10 to load from.

In addition to the above and as previously indicated, different transporting vehicles 20 and different loading vehicles 10 may have different maneuverability. The maneuverability may affect an ability of a vehicle 10, 20 to access a specific location within the loading area 3. The maneuverability of a vehicle 10, 20 may be a factor affected by e.g. turn radius (which varies significantly between e.g. Ackermann steered vehicles and articulated vehicles), chassis (a robust chassis and off-road suspension system generally allow a vehicle to absorb shocks and impacts while maintaining stability), suspension (a well-designed suspension helps keep all wheels in contact with the ground, improving traction and maneuverability), ground clearance (a distance between the lowest point of the vehicle's 10, 20 undercarriage and the ground, higher ground clearance prevents the vehicle 10, 20 from getting stuck on uneven surfaces or high obstacles 5), traction and differential systems (vehicles provided with features like all-wheel drive (AWD), four-wheel drive (4WD), or differential locks generally have better traction on slippery or uneven surfaces compared to vehicles 10, 20 without such systems), tires (off-road tires with aggressive tread patterns provide better grip on challenging surfaces like mud, sand, and rocks), water fording depth (some off-road vehicles have the capability to ford through water bodies without causing damage to vehicle components), engine power and torque (sufficient power and torque enable a vehicle 10, 20 to overcome resistance caused by challenging terrains and obstacles), weight distribution (a well-balanced weight distribution helps maintain stability while traversing obstacles, especially on uneven terrain), structural strength (vehicles 10, 20 designed with strong and durable materials can withstand impacts and stresses encountered during off-road driving) etc.

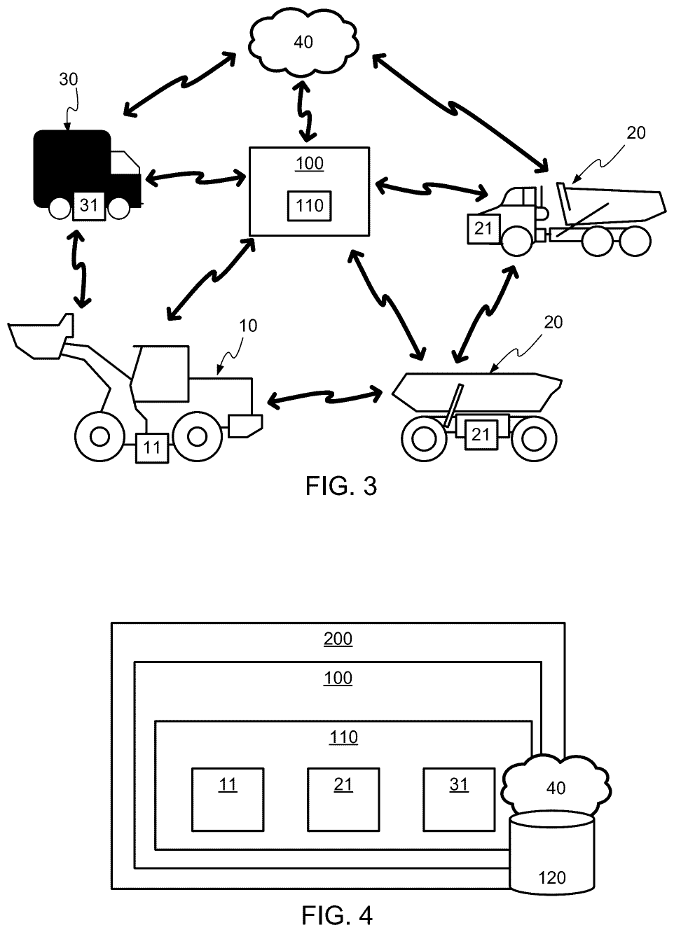

In FIG. 3, a schematic view of a computer system 100 is shown. The computer system 100 comprises processing circuitry 110 configured to perform, or cause performance of one or more actions, tasks or features relating to teachings of the present disclosure. In FIG. 3, the computer system 100 is in communication, advantageously wirelessly, with one or more vehicles 10, 20, 30 within the confined off-road area 1. The computer system 100 may, in some examples, further be in communication with a cloud server 40 (or cluster of servers). To this end, the vehicles 10, 20, 30 comprises processing circuitry 11, 21, 31 for controlling, or causing communication, with the computer system 100.

As emphasis of the present application is off-road routing, details of all features of the vehicles 10, 20, 30 within the confined off-road area 1 will be kept at a minimum. However, as the skilled person will appreciate, the vehicles 10, 20, 30 comprises all necessary vehicle units and associated functionality such that it may operate as the skilled person would expect of a vehicle 10, 20, 30, such as a powertrain, chassis, and various control systems. However, a vehicle 10, 20, 30 of the present disclosure comprises one or more propulsion sources. The propulsion source may be any suitable propulsion source exemplified by, but not limited to, one or more or a combination of an electrical motor, a combustion engine such as a diesel, gas or gasoline powered engine. The vehicle 10, 20, 30 further comprises an energy source suitable for providing energy for the propulsion source. That is to say, if the propulsion source is an electrical motor, a suitable energy source would be a battery or a fuel cell. The vehicle 10, 20, 30 further comprises sensor circuitry arranged to detect, measure, sense or otherwise obtain data relevant for operation of the vehicle 10, 20, 30. The data relevant for operation of the vehicle 10, 20, 30 may be exemplified by, but not limited to, one or more of a speed of the vehicle 10, 20, 30, a weight of the vehicle 10, 20, 30, an inclination of the vehicle 10, 20, 30, a status (state of charge, fuel level etc.) of the energy source of the vehicle 10, 20, 30 etc.

In order to communicate with the computer system 100, the vehicle 10, 20, 30 may comprise communications circuitry configured for communication with, to the vehicle 10, 20, 30, external devices. The communications circuitry is advantageously a communications circuitry configurable to provide a wireless communication interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc.

As partly indicated in FIG. 3 the vehicles 10, 20, 30 may communicate directly with each other and/or meshed through computer system 100, or other vehicles 10, 20, 30. Communication with the other vehicles 10, 20, 30 may be provided by the previously mentioned wireless interfaces, and/or any suitable vehicle-to-vehicle (V2V) communications protocol exemplified by, but not limited to Dedicated Short-Range Communications (DSRC), Cellular Vehicle-to-Everything (C-V2X), IEEE 802.11p, LTE-V (LTE-V2X), 5G NR (New Radio) V2X, etc.

The vehicle 10, 20, 30 may further be operatively connected to a Global Navigation Satellite System (GNSS) exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The vehicle 10, 20, 30 may be configured to utilize data obtain from the GNSS 10, 20, 30 to determine a geographical location of the vehicle 10, 20, 30.

It should be mentioned that the centralized description of the computer system 100 shown in FIG. 3 is one example. In FIG. 4, another example of a computer system 100 according to the present disclosure is presented. In FIG. 4, the processing circuitry 110 of the computer system 100 comprises processing circuitry 11 of one or more loaders 10 within the confined off-road area 1. Optionally, in some examples, the processing circuitry 110 of the computer system 100 may further comprises processing circuitry 21 of one or more haulers 20 within the confined off-road area 1. Additionally, or alternatively, in some examples, the processing circuitry 110 of the computer system 100 may further comprises processing circuitry 31 of one or more other vehicles 30 within the confined off-road area 1. Additionally, or alternatively, in some examples, the processing circuitry 110 of the computer system 100 may further comprise part of, or be comprised by, the cloud server 40. As seen in FIG. 4, the computer system 100 may form part of a site management system 200. The site management system 200 may comprise (or be operatively connected to) the computer system 100. The site management system 200 may obtain any data available to the computer system 100. The site management system 200 may configured the computer system 100 to perform or cause any action or feature described herein. The site management system 200 may be configured to control the routing of the one or more vehicles in the confined off-road area 1.

The site management system 200 may be a software system, a hardware system or a system of both software and hardware. The site management system 200 may be configured to assist in planning, managing, and optimizing operation of an associated site, i.e. the confined off-road area 1. The site management system 200 may be configured to e.g. schedule and monitor equipment maintenance and repair, inventory levels of materials and supplies, production and productivity metrics, safety and compliance data, employee training and development records etc.

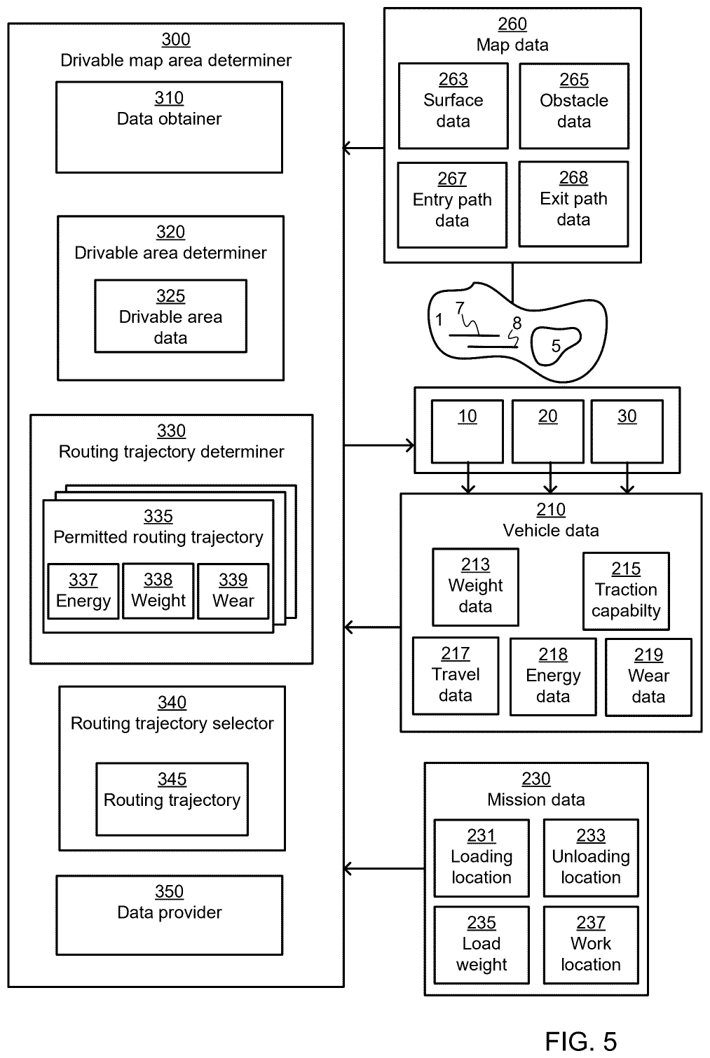

In FIG. 5 an exemplary software architecture of a drivable map area determiner 300 is shown. The drivable map area determiner 300 may be implemented as part of the computer system 100, the site management system 200 and/or the processing circuitry 110 of the computer system 100 may be configured to perform, or cause performance of the functions, features or examples of the drivable map area determiner 300.

The drivable map area determiner 300 comprises a data obtainer 310 and a drivable area determiner 320 and a data provider 350. In some examples, the drivable map area determiner 300 further comprises and optional routing trajectory determiner 330 and an optional routing trajectory selector 340.

The data obtainer 310 is configured to obtain map data 260 of a confined off-road area 1. The map data 260 may be obtained from a storage device 120 that may e.g. be external to the drivable map area determiner 300, connected to the cloud server 40 and/or form part of the computer system 100. The map data 260 may comprise any data relevant for describing the confined off-road area 1.

In some examples, the map data 260 comprise, or is configured to comprise, obstacle data 265. The obstacle data 265 is associated with obstacles 5 within the confined off-road area 1. The obstacle data 265 may comprise any data suitable for describing an obstacle 5 within confined off-road area 1. Obstacle data 265 may comprise e.g. position data, size data, and/or classification data 225 of the obstacle 5. The classification data may comprise a type of the obstacle 5. The type of the obstacle 5 may be one of e.g. a rock, a boulder, a hole, a water crossing, a puddle, a mud pit, a cam, a pile of snow, a pile of gravel, loose gravel, loose sand, a patch of ice, a steep incline, a steep decline, a tree or other vegetation, a pothole, construction debris, construction equipment etc. The classification data of the obstacle 5 may additionally, or alternatively, comprise one or more of an indication of a weight of the obstacle 5, and/or indication of a viscosity of the obstacle 5, an indication of a movability of the obstacle 5. The obstacle data 265 may further indicate how difficult an associated obstacle 5 is to traverse. This may be described by a traction capability required to traverse the obstacle 5. It should be mentioned that the a traction capability of a vehicle 10, 20, 30 may depend on a speed of the vehicle and to this end, the obstacle data 265 may associate the required traction capability with a minimum speed and/or a maximum speed of the vehicle 10, 20, 30. Additionally, or alternatively, the map data 260 may comprise surface condition data 263, or surface data 263 for short. The surface data 263 may comprise on or more of topography data (e.g. high points, low points, elevation changes etc.), slope data (e.g. steepness, direction of slopes, etc.), material data (e.g. rocks, minerals, soil, etc.), density data (e.g. metric of how densely packed the surface is), texture data (e.g. roughness, smoothness, etc.). The map data 260 may further comprise entry path data 267 indicating a location of the entry path 7 within the confined off-road area 1. Further, the map data 260 may further comprise exit path data 268 indicating a location of the exit path 8 within the confined off-road area 1.

The data obtainer 310 is further configured to obtain vehicle data 210 for a specific vehicle 10, 20, 30. The specific vehicle 10 may be any vehicle 10, 20, 30 within the confined off-road area 1. The vehicle data 210 may comprise any data for the vehicle 10, 20, 30. In some examples, the vehicle data 210 comprise weight data 213 of the specific vehicle 10, 20, 30. The weight data 213 may describe a current weight of the specific vehicle 10, 20, 30, an unloaded weight of the specific vehicle 10, 20, 30, a weight of a cargo of the specific vehicle 10, 20, 30 etc. In some examples, the vehicle data 210 may comprise a traction capability 215 of the specific vehicle 10, 20, 30. The traction capability 215 of the specific vehicle 10, 20, 30 may describe an ability of the vehicle to traverse obstacles 5. The traction capability of the specific vehicle 10, 20, 30 may depend on e.g. chassis (a robust chassis and off-road suspension system generally allow a vehicle to absorb shocks and impacts while maintaining stability), suspension (a well-designed suspension helps keep all wheels in contact with the ground, improving traction and maneuverability), ground clearance (a distance between the lowest point of the specific vehicle's 10, 20, 30 undercarriage and the ground, higher ground clearance prevents the specific vehicle 10, 20, 30 from getting stuck on uneven surfaces or high obstacles), traction and differential systems (vehicles provided with features like all-wheel drive (AWD), four-wheel drive (4WD), or differential locks generally have better traction on slippery or uneven surfaces compared to specific vehicles 10, 20, 30 without such systems), tires (off-road tires with aggressive tread patterns provide better grip on challenging surfaces like mud, sand, and rocks), water fording depth (some off-road vehicles have the capability to ford through water bodies without causing damage to vehicle components), engine power and torque (sufficient power and torque enable a specific vehicle 10, 20, 30 to overcome resistance caused by challenging terrains and obstacles), weight distribution (a well-balanced weight distribution helps maintain stability while traversing obstacles, especially on uneven terrain), structural strength (specific vehicles 10, 20, 30 designed with strong and durable materials are able to withstand impacts and stresses encountered during off-road driving) etc. The vehicle data 210 may, in some examples, comprise travel data 217 of the specific vehicle 10, 20, 30. The travel data 217 may describe one or more of a maximum speed, a minimum speed or a preferred travel speed of the specific vehicle 10, 20, 30. The vehicle data 210, may in some examples, comprise energy data 218 of the specific vehicle 10, 20, 30. The energy data 218 may indicate energy consumption of the specific vehicle 10, 20, 30 e.g. at different loads, speeds, inclinations etc. The vehicle data 210, may in some examples, comprise wear data 219 of the specific vehicle 10, 20, 30. The wear data 219 may indicate a wear of the specific vehicle 10, 20, 30 i.e. how much damage or how long time is the specific vehicle 10, 20, 30 permitted to travel at e.g. different loads, speeds, inclinations etc. before service or maintenance is required.

In some examples, the data obtainer 310 may be configured to obtain mission data 230. The mission data 230 may be associated with a specific vehicle 10, 20, 30, but may, in some examples, be general without specifying a specific vehicle 10, 20, 30. The mission data describe, at least part of, a work mission for a specific vehicle 10, 20, 30 within the confined off-road area 1. The mission data 230 may describe a loading location 231 within the confined off-road area 1, i.e. a location at which goods is to be loaded onto the specific vehicle 10, 20, 30. The mission data 230 may describe an unloading location within the confined off-road area 1, i.e. a location at which goods loaded onto the specific vehicle 10, 20, 30 is to be unloaded. The mission data 230 may describe a general work location 237 describing a location where e.g. an obstacle 5 is to be removed, a vehicle 10, 20, 30 needs saving etc. The mission data 230 may further comprise a load weight 235 of the mission, i.e. a load that the specific vehicle 10, 20, 30 is expected to load and/or unload and the respective loading location 231 or unloading location 233.

The drivable area determiner 320 of the drivable map are determiner 300 is configured to determine drivable area data 325 for the specific vehicle 10, 20, 30 within the confined off-road area 1. As the name indicates, the drivable area data 325 is data that indicates what regions (areas, sections, portions etc.) of the confined off-road area 1 that are drivable for a specific vehicle 10. To this end, the drivable area determiner 320 is configured to determine the drivable area data 325 based on the map data 260 and the vehicle data 210. This means that different specific vehicle 10, 20, 30 may have different drivable area 325 depending on e.g. obstacle data 265 indicating that some obstacles 5 are traversable by some specific vehicles 10, 20, 30 and impassable to other specific vehicles 10, 20, 30. The drivable area determiner 320 may be configured to determine the drivable area data 325 based on the obstacle data 265 and the traction capability 215 of the specific vehicle 10, 20, 30. That is to say, if the obstacle data 265 indicate that an obstacle 5 is impassable by the traction capability 215 of the specific vehicle 10, 20, 30, an area blocked by that obstacle 5 will not be part of the drivable area data 325 for the specific vehicle 10, 20, 30. Correspondingly, if the obstacle data 265 indicate that an obstacle 5 is passable/traversable by the traction capability 215 of the specific vehicle 10, 20, 30, that obstacle 5 is ignored and a footprint, i.e. an area occupied by the obstacle 5, will form part of the drivable area data 325 for the specific vehicle 10, 20, 30. Additionally, or alternatively, the drivable area determiner 320 may be configured to determine the drivable area data 325 based on the obstacle data 265, the travel data 217 and optionally the traction capability of the specific vehicle 10, 20, 30. This means that obstacles 5 that require a speed higher than a minimum speed of the specific vehicle 10, 20, 30 and/or a speed lower than a maximum speed of the specific vehicle 10, 20, 30 are ignored when determining the drivable area data 325 for the specific vehicle 10, 20, 30.

It should be mentioned that the drivable area data 325 may specify minimum and/or maximum speeds for the specific vehicle 10, 20, 30 at some areas of the drivable area data 325. If some obstacles 5 require a certain minimum or maximum speed to traverse, the specific vehicle 10, 20, 30 will have to be at, below or above that certain speed in order to traverse the obstacle 5. Further, the traction capability 215 of the specific vehicle 10, 20, 30 may change with a weight of the specific vehicle 10, 20, 30. That is to say, the specific vehicle 10, 20, 30 may be able to traverse some obstacles 5 when the specific vehicle 10, 20, 30 is unloaded, but may be unable to traverse the same obstacles when the specific vehicle 10, 20, 30 is loaded. Correspondingly, maximum and minimum speeds of the specific vehicle 10, 20, 30 may change depending on a current weight of the specific vehicle 10, 20, 30. To this end, the drivable area data 325 may be provided not only for a specific vehicle 10, 20, 30, but also for specific loads of the specific vehicle 10, 20, 30.

The drivable area 325 for a specific vehicle 10, 20, 30 allows e.g. a site management system 200 to quickly and easily determine what vehicles are able to go where and may decide to increase a number of a specific type of specific vehicle 10, 20, 30 of a fleet of vehicles and decrease a number of a different type of specific vehicle 10, 20, 30 from the fleet of vehicles.

In a non-limiting example, assume that an obstacle 5 in the form of a deep pool of water is preventing e.g. a tractor trailer transporting vehicle 20 from accessing the second level ii of the confined off-road area 1. The drivable area data 325 for the tractor trailer transporting vehicle 20 will clearly indicate that the second level ii is not part of the drivable area and inaccessible for the tractor trailer transporting vehicle 20. Rather than attempting to traverse the obstacle 5 and risk getting stuck or damaged, the tractor trailer transporting vehicle 20 may be safely routed to other part of the confined off-road area 1.

To this end, the data provider 350 is configured to provide the drivable area data 325 for routing of the specific vehicle 10, 20, 30. This may means providing the drivable area data 325 to the specific vehicle 10, 20, 30 such that an operator, or an autonomous controller, of the specific vehicle 10, 20, 30 may safely route the specific vehicle 10, 20, 30. In some examples, the drivable area data 325 may be provided to the site management system 200 for e.g. planning, fleet management, obstacle management etc. The drivable area data enables differentiation in routing between specific vehicle 10, 20, 30 based on their respective drivable area data 325.

As mentioned, in some examples, the drivable map are determiner 300 may comprise the routing trajectory determiner 330. The routing trajectory determiner 330 is configured to determine at least one permitted routing trajectory 335 based on the mission data 230 and the drivable area data 325 of the specific vehicle 10, 20, 30. The permitted routing trajectory 335 indicate a route for the specific vehicle 10, 20, 30 to complete the work mission according to the mission data 230 (e.g. travel to the loading location 231 and then to the unloading location 233). In some examples, more than one permitted routing trajectory may be available to complete the mission specified by the mission data 230. To this end, the routing trajectory selector 340 may be configured to determine a plurality of different permitted routing trajectories 335. In some examples, for specific mission data 230, a plurality of permitted routing trajectories 335 are determined for one specific vehicle 10, 20, 30. In some examples, for specific mission data 230, a plurality of permitted routing trajectories 335 are determined where at least two permitted routing trajectories are associated with different specific vehicles 10, 20, 30. In some examples, the routing trajectory determiner may be configured to associate each permitted routing trajectory with a weight profile 338. The weight profile 338 describe how a weight of the specific vehicle 10, 20, 30 changes throughout the permitted routing trajectory 335, i.e. throughout the mission. For instance, the weight profile 338 will indicate an increase of a vehicle weight at the loading location 230 corresponding to the load weight 235 of the mission data 230 and a corresponding decrease in vehicle weight at the unloading location 233 (assuming the entire load weight 235 is unloaded at the same unloading location 233 which may not always be the case). As indicated above, the weight profile 338 may cause the drivable area data 325 to change, such that, when loaded, the specific vehicles 10, 20, 30 is forced to take a different route to the unloading location 233 than from the unloading location 231 (assuming back and forth travel). To this end, the routing trajectory determiner 330 may be configured to determine a plurality of different permitted routing trajectories 335 wherein at least two permitted routing trajectories 335 differ in the load weight 235 of the mission data 230; it may be more cost effective to load less if this allows the specific vehicle to take a significantly shorter or otherwise more energy efficient route when loaded. Based on e.g. vehicle data 210 and/or map data 260, each permitted routing trajectory 335 may be associated with an energy consumption indicator 337 indicating an expected energy consumption of the specific vehicle 10, 20, 30 for competing the respective permitted routing trajectory. Additionally, or alternatively, based on e.g. vehicle data 210 and/or map data 260, each permitted routing trajectory 335 may be associated with a wear indicator 339 indicating an expected wear of the specific vehicle 10, 20, 30 for competing the respective permitted routing trajectory. Additionally, or alternatively, based on e.g. vehicle data 210 and/or map data 260, each permitted routing trajectory 335 may be associated with further data (not shown) such as a time to complete the permitted routing trajectory 335, a cost for competing the permitted routing trajectory 335 etc.

Determining the wear indicator 339 and/or the energy consumption indicator 337 further based on the weight profile 338 for the specific vehicle 10, 20, 30 and the specific permitted routing trajectory is beneficial as the estimated indicator 337, 339 will have improved accuracy. By further adding in e.g. topography of the map data 260, very accurate models of energy consumption and wear for different permitted routing trajectories are possible.

As mentioned, in some examples, the drivable map are determiner 300 may comprise the routing trajectory selector 340. The routing trajectory selector 340 is configured to select one of the plurality of permitted routing trajectories 335 as a routing trajectory 345 for the specific vehicle 10, 20, 30. The routing trajectory selector 340 may be configured to select the routing trajectory 345 from the permitted routing trajectories 335 based on any suitable data. In some examples, the routing trajectory selector 340 is configured to select the routing trajectory 345 from the permitted routing trajectories 335 based on the energy consumption indicator 337. In some examples, the routing trajectory selector 340 is configured to select the routing trajectory 345 from the permitted routing trajectories 335 based on the wear indicator 339. In some examples, the routing trajectory selector 340 is configured to select the routing trajectory 345 from the permitted routing trajectories 335 based on the time it takes to complete the permitted routing trajectory 335. In some examples, the routing trajectory selector 340 is configured to select the routing trajectory 345 from the permitted routing trajectories 335 by weighting two or more metrics (e.g. weight, time, cost, energy, wear, etc.) of the permitted routing trajectories 335.

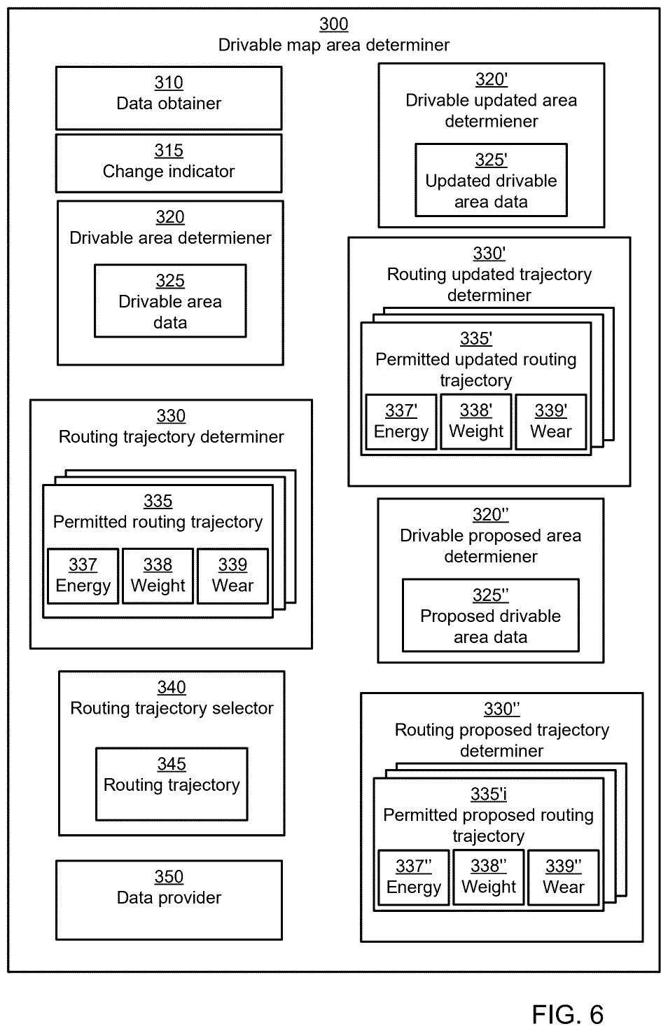

In FIG. 6, a drivable map are determiner 300 according to an optional example is shown. The drivable map are determiner 300 of FIG. 6 may comprise all features presented in reference to FIG. 5 and these will not be repeated once more in reference to FIG. 6. The drivable map are determiner 300 of FIG. 6 further comprise a change indicator 315. The change indicator 315 is configured to indicate changes in data relevant for providing the drivable area data 325. Such changes may comprise changes in vehicle data 210, changes in map data 260 and/or changes in mission data 230. The change indicator 315 may monitor the vehicle data 210, the map data 260 and/or the mission data 230 to detect any changes. In some examples, the change indicator 315 may be instructed to simulate a proposed change. That is to say, the map are determiner 300 and/or an operator of the map are determiner 300, may instruct the data indicator 315 to indicate a specific change in the vehicle data 210, the map data 260 and/or the mission data 230. Such changes may comprise removal or reworking of an obstacle 5 indicated by the map data 260, change of a load weight 235 indicated by the mission data 230, change of weight data 213 of the vehicle data 210, change of a type of vehicle etc.

The drivable map area determiner 300 of FIG. 6 further comprise a drivable updated area determiner 320′. The drivable updated area determiner 320′ is configured to, in response to the change indicator 315 indicating a change, determine updated drivable area data 325′ based on the updated vehicle data 210, map data 260 and/or the mission data 230. The updated drivable area data 325′ may be provided to the data provider 350 for routing of the specific vehicle 10, 20, 30 and/or to an routing updated trajectory determiner 330′ for determining of one or more updated permitted routing trajectories 335′. The updated permitted routing trajectories 335′ may be determined correspondingly to the permitted routing trajectories 335 introduced in reference to FIG. 5 and may consequently comprise updated energy consumption indicator 337′, an updated weight profile 338′ and/or an updated wear indicator 339′. It should be mentioned that, if only the mission data 230 has changed, the drivable updated area determiner 320′ may be omitted and the updated mission data may be provided to the routing updated trajectory determiner 330′ together with the drivable area data 325.

The drivable updated area determiner 320′ and the routing updated trajectory determiner 330′ allows for agility in the drivable map area determiner 300. The confined off-road area 1 may be susceptible to changes due to weather, dropping of rocks, changes in locations of the levels i, ii, iii, iv etc. which all may cause vehicles 10, 20, 30 difficulties in routing. As soon as changes are detected, these may be considered when providing drivable area data 325 for routing of the specific vehicle 10, 20, 30. This reduces a risk that vehicle 10, 20, 30 are damaged or get stuck.

Correspondingly, drivable map are determiner 300 of FIG. 6 may comprise a drivable proposed area determiner 320″. The drivable proposed area determiner 320″ is configured to, in response to the change indicator 315 indicating a proposed change (i.e. a change not detected by differences in the data), determine proposed drivable area data 325″ based on the proposed vehicle data 210, map data 260 and/or the mission data 230. The proposed drivable area data 325″ may be provided to the data provider 350 for routing of the specific vehicle 10, 20, 30 and/or to an routing proposed trajectory determiner 330″ for determining of one or more proposed permitted routing trajectories 335″. The proposed permitted routing trajectories 335″ may be determined correspondingly to the permitted routing trajectories 335 introduced in reference to FIG. 5 and may consequently comprise proposed energy consumption indicator 337″, an proposed weight profile 338″ and/or an proposed wear indicator 339″. It should be mentioned that, if only the mission data 230 has changed, the drivable proposed area determiner 320″ may be omitted and the proposed mission data may be provided to the routing proposed trajectory determiner 330″ together with the drivable area data 325.

The drivable proposed area determiner 320′ and the routing proposed trajectory determiner 330′ allows for simulation of changes in data for the drivable map are determiner 300. For instance, by simulating removal of one or more obstacles 5 the permitted routing trajectories 335 may be compared to the proposed permitted routing trajectories 335″ and benefits from removing the obstacle(s) 5 may be evaluated. Further to this, mission data 230 may be provided indicating a mission to remove the obstacle(s) 5 and the cost of executing this mission may be compared to the gains provided by the proposed permitted routing trajectories 335″.

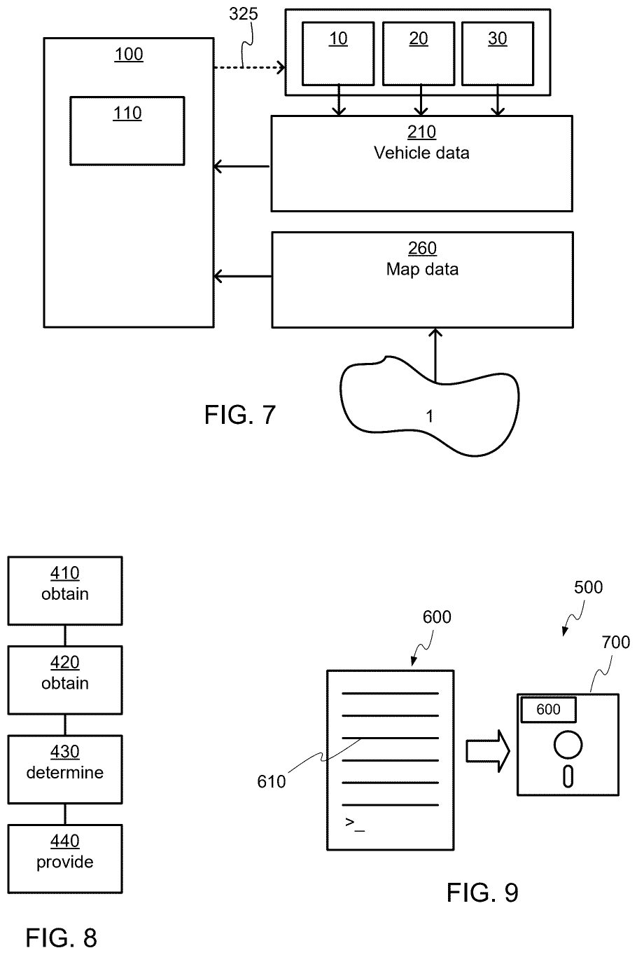

FIG. 7 is an exemplary computer system 100 according to the present discloser. The computer system 100 comprises processing circuitry 110 configured to obtain vehicle data 210 of a specific vehicle 10, 20, 30 and to obtain map data 260 of a confined off-road area 1. The processing circuitry 110 is further configured to determine drivable area data 325 for the specific vehicle 10, 20, 30 within the confined off-road area 1 based on the vehicle data 210 and the map data 260, and provide the drivable area data 325 for routing of the specific vehicle 10, 20, 30 within the confined off-road area 1.

The computer system 100 of FIG. 7 may be modified to comprise, or cause any feature, effect or example presented herein.

In FIG. 8, a block diagram of a method 400 according to the present disclosure is shown. The method 400 may be a computer implemented method. The computer system 100 of the present disclosure may be configured to perform, or cause, one or more features of the method 400. The site management system 200 of the present disclosure may be configured to perform, or cause, one or more features of the method 400. The method 400 may be modified to comprise, or cause any feature, effect or example presented herein.

The method 400 comprises obtaining 410 vehicle data 210 of a specific vehicle 10, 20, 30 and obtaining 420 map data 260 of a confined off-road area 1. The obtaining 410, 420 may be performed as indicated e.g. in reference to the data obtainer 310 introduced with reference to FIG. 5. The method 400 further comprises determining, 430 drivable area data 325 for the specific vehicle 10, 20, 30 within the confined off-road area 1 based on the vehicle data 210 and the map data 260. The determining 430 may be performed as indicated e.g. in reference to the drivable area determiner 320 introduced with reference to FIG. 5. The method 400 further comprises providing 440 the drivable area data 325 for routing of the specific vehicle 10, 20, 30 within the confined off-road area 1. The providing 440 may be performed as indicated e.g. in reference to the data provider 350 introduced with reference to FIG. 5.

In FIG. 9 a computer program product 500 is shown. The computer program product 500 comprises a computer program 600 and a non-transitory computer readable medium 700. The computer program 600 may be stored on the computer readable medium 700. The computer readable medium 700 is, in FIG. 9, exemplified as a vintage 5,25″ floppy disc, but may be embodied as any suitable non-transitory computer readable medium such as, but not limited to, hard disk drives (HDDs), solid-state drives (SSDs), optical discs (e.g., CD-ROM, DVD-ROM, CD-RW, DVD-RW), USB flash drives, magnetic tapes, memory cards, Read-Only Memories (ROM), network-attached storage (NAS), cloud storage etc.

The computer program 600 comprises instruction 610 e.g. program instruction, software code, that, when executed by processing circuitry cause the processing circuitry to perform the method 400 introduced herein with reference to FIG. 8.

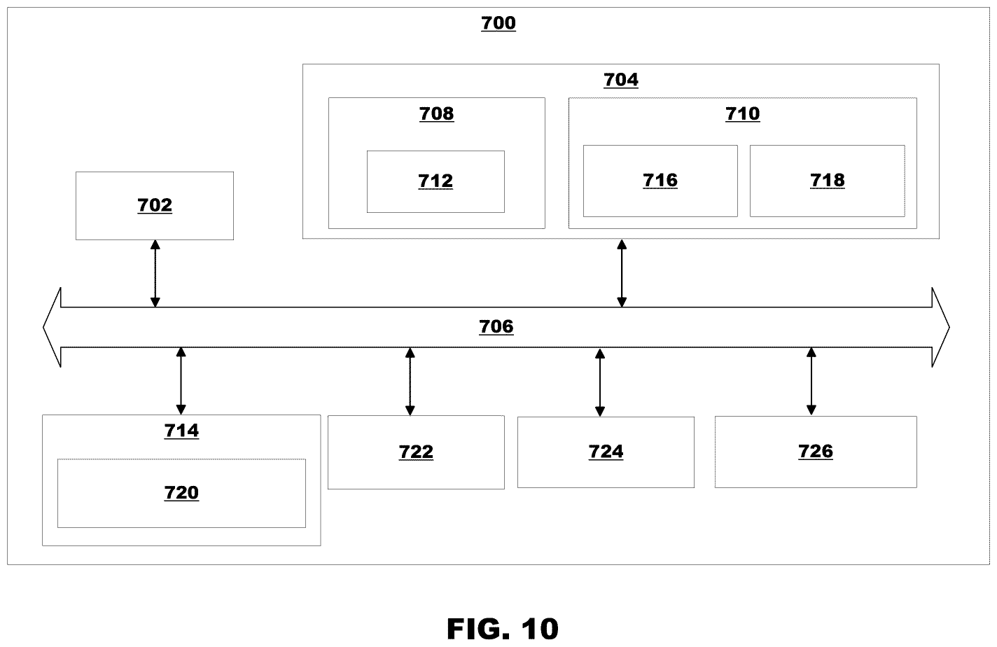

FIG. 10 is a schematic diagram of a computer system 700 for implementing examples disclosed herein. The computer system 700 is adapted to execute instructions from a computer-readable medium to perform these and/or any of the functions or processing described herein. The computer system 700 may be connected (e.g., networked) to other machines in a LAN, an intranet, an extranet, or the Internet. While only a single device is illustrated, the computer system 700 may include any collection of devices that individually or jointly execute a set (or multiple sets) of instructions to perform any one or more of the methodologies discussed herein. The computer system 700 of FIG. 10, may be the computer system 100 introduced with reference to FIG. 2. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 700 may comprise at least one computing device or electronic device capable of including firmware, hardware, and/or executing software instructions to implement the functionality described herein. The computer system 700 may include processing circuitry 702 (e.g., processing circuitry including one or more processor devices or control units), a memory 704, and a system bus 706. The processing circuitry 702 may be the processing circuitry 110 introduced with reference to FIG. 3. The computer system 700 may include at least one computing device having the processing circuitry 702. The system bus 706 provides an interface for system components including, but not limited to, the memory 704 and the processing circuitry 702. The processing circuitry 702 may include any number of hardware components for conducting data or signal processing or for executing computer code stored in memory 704. The processing circuitry 702 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 702 may further include computer executable code that controls operation of the programmable device.

The system bus 706 may be any of several types of bus structures that may further interconnect to a memory bus (with or without a memory controller), a peripheral bus, and/or a local bus using any of a variety of bus architectures. The memory 704 may be one or more devices for storing data and/or computer code for completing or facilitating methods described herein. The memory 704 may include database components, obstacle code components, script components, or other types of information structure for supporting the various activities herein. Any distributed or local memory device may be utilized with the systems and methods of this description. The memory 704 may be communicably connected to the processing circuitry 702 (e.g., via a circuit or any other wired, wireless, or network connection) and may include computer code for executing one or more processes described herein. The memory 704 may include non-volatile memory 708 (e.g., read-only memory (ROM), erasable programmable read-only memory (EPROM), electrically erasable programmable read-only memory (EEPROM), etc.), and volatile memory 710 (e.g., random-access memory (RAM)), or any other medium which can be used to carry or store desired program code in the form of machine-executable instructions or data structures and which can be accessed by a computer or other machine with processing circuitry 702. A basic input/output system (BIOS) 712 may be stored in the non-volatile memory 708 and can include the basic routines that help to transfer information between elements within the computer system 700.

The computer system 700 may further include or be coupled to a non-transitory computer-readable storage medium such as the storage device 714, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 714 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 714 and/or in the volatile memory 710, which may include an operating system 716 and/or one or more program modules 718. All or a portion of the examples disclosed herein may be implemented as a computer program 720 stored on a transitory or non-transitory computer-usable or computer-readable storage medium (e.g., single medium or multiple media), such as the storage device 714, which includes complex programming instructions (e.g., complex computer-readable program code) to cause the processing circuitry 702 to carry out actions described herein. Thus, the computer-readable program code of the computer program 720 can comprise software instructions for implementing the functionality of the examples described herein when executed by the processing circuitry 702. In some examples, the storage device 714 may be a computer program product (e.g., readable storage medium) storing the computer program 720 thereon, where at least a portion of a computer program 720 may be loadable (e.g., into a processor) for implementing the functionality of the examples described herein when executed by the processing circuitry 702. The processing circuitry 702 may serve as a controller or control system for the computer system 700 that is to implement the functionality described herein.

The computer system 700 may include an input device interface 722 configured to receive input and selections to be communicated to the computer system 700 when executing instructions, such as from a keyboard, mouse, touch-sensitive surface, etc. Such input devices may be connected to the processing circuitry 702 through the input device interface 722 coupled to the system bus 706 but can be connected through other interfaces, such as a parallel port, an Institute of Electrical and Electronic Engineers (IEEE) 1394 serial port, a Universal Serial Bus (USB) port, an IR interface, and the like. The computer system 700 may include an output device interface 724 configured to forward output, such as to a display, a video display unit (e.g., a liquid crystal display (LCD) or a cathode ray tube (CRT)). The computer system 700 may include a communications interface 726 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1. A computer system 100 comprising processing circuitry 110 configured to: obtain vehicle data 210 of a specific vehicle 10, 20, 30; obtain map data 260 of a confined off-road area 1; determine drivable area data 325 for the specific vehicle 10, 20, 30 within the confined off-road area 1 based on the vehicle data 210 and the map data 260; and provide the drivable area data 325 for routing of the specific vehicle 10, 20, 30 within the confined off-road area 1.

Example 2. The computer system 100 of example 1, wherein the processing circuitry 110 is further configured to: obtain mission data 230 for the specific vehicle 10, 20, 30, the mission data 230 comprising an indication of a loading location 231 and/or an unloading location 233 within the confined off road area 1; determine one or more permitted routing trajectories 335 for the specific vehicle 10, 20, 30 to travel to/from the loading location 231 and/or an unloading location 233 based on the drivable area data 325 and the mission data 230; and select one of the one or more permitted routing trajectories 335 as a routing trajectory 345 for routing of the specific vehicle 10, 20, 30.

Example 3. The computer system 100 of example 2, wherein the processing circuitry 110 is configured to: select the routing trajectory 345 based on an energy consumption indicator 337 and/or a vehicle component wear indicator 339 for the specific vehicle 10, 20, 30 to complete the permitted routing trajectories 335.

Example 4. The computer system 100 of example 2 or 3, wherein the mission data 230 further comprises load weight data 235 indicating a weight of goods to be loaded at the loading location 231 and/or unloaded at the unloading location 233.

Example 5. The computer system 100 of any one of examples 1 to 4, wherein the vehicle data 210 comprises weight data 213 for the specific vehicle 10, 20, 30, the map data 260 comprises surface condition data 263 for the confined off-road area 1, and the processing circuitry 110 is further configured to: determine the drivable area data 325 based on the weight data 213 and the surface condition data 263.

Example 6. The computer system 100 of example 4 and 5, wherein the processing circuitry 110 is configured to: determine the permitted routing trajectories 335 further based on a weigh profile 338 for the specific vehicle 10, 20, 30 for traveling to/from the loading location 231 and/or the unloading location 233, wherein the weight profile 338 is determined based on the weight data 213 of the specific vehicle 10, 20, 30 and the load weight data 235.

Example 7. The computer system 100 of any one of examples 1 to 6, wherein the vehicle data 210 further comprises a traction capability 215 of the specific vehicle 10, 20, 30, the map data 260 comprises obstacle data 265 indicating one or more obstacles 5 of the confined off-road data 1, and the processing circuitry 110 is further configured to: determine the drivable area data 325 further based on the obstacle data 265 and the traction capability 215 of the specific vehicle 10, 20, 30.

Example 8. The computer system 100 of example 7, wherein the traction capability 215 comprises one or more of a wheel base, a ground clearance, traction functionality or an available drive torque of the specific vehicle 10, 20, 30.

Example 9. The computer system 100 of any one of examples 1 to 8, wherein the vehicle data 210 further comprises travel data 217 of the specific vehicle 10, 20, 30, and the processing circuitry 110 is further configured to: determine the drivable area data 325 further based on the travel data 217 of the specific vehicle 10, 20, 30.

Example 10. The computer system 100 of example 9, wherein the travel data 217 indicate at least one of a maximum speed, a minimum speed or a preferred travel speed.

Example 11. The computer system 100 of any one of examples 1 to 10, wherein the processing circuitry 110 is further configured to: obtain an indication of an update of the vehicle data 210 and/or the map data 260; determine updated drivable area data 325′ for the specific vehicle 10, 20, 30 within the confined off-road area 1 based on updated vehicle data and/or updated map data; and provide the updated drivable area data 325′ for routing of the specific vehicle 10, 20, 30 within the confined off-road area 1.

Example 12. The computer system 100 of any one of examples 2 to 11, wherein the processing circuitry 110 is further configured to: obtain an indication of an update of the mission data 210; and determine one or more updated permitted routing trajectories 335′ for the specific vehicle 10, 20, 30 to travel to/from the loading location 231 and/or an unloading location 233 based on the drivable area data 325 and the updated mission data.

Example 13. The computer system 100 of any one of examples 1 to 12, wherein the processing circuitry 110 is further configured to: obtain an indication of a proposed change of the map data 260; and determine proposed drivable area data 325″ for the specific vehicle 10, 20, 30 within the confined off-road area 1 based on the proposed updated map data 325″; and provide the proposed drivable area data 325″ and the drivable area data 325 as decision data for determining if the confined off-road area 1 is to be modified in line with the proposed change of the map data 260 or not.

Example 14. The computer system 100 of example 13, wherein the map data 260 comprises obstacle data 265 indicating one or more obstacles 5 of the confined off-road data 1 and the proposed change of the map data 260 comprises modification of at least one obstacle 5.

Example 15. The computer system 100 of example 1, wherein the processing circuitry 110 is further configured to: obtain mission data 230 for the specific vehicle 10, 20, 30, the mission data 230 comprising an indication of a loading location 231 and/or an unloading location 233 within the confined off road area 1; determine one or more permitted routing trajectories 335 for the specific vehicle 10, 20, 30 to travel to/from the loading location 231 and/or an unloading location 233 based on the drivable area data 325 and the mission data 230; and select one of the one or more permitted routing trajectories 335 as a routing trajectory 345 for routing of the specific vehicle 10, 20, 30; wherein the processing circuitry 110 is configured to: select the routing trajectory 345 based on an energy consumption indicator 337 and/or a vehicle component wear indicator 339 for the specific vehicle 10, 20, 30 to complete the permitted routing trajectories 335; wherein the mission data 230 further comprises load weight data 235 indicating a weight of goods to be loaded at the loading location 231 and/or unloaded at the unloading location 233; wherein the vehicle data 210 comprises weight data 213 for the specific vehicle 10, 20, 30, the map data 260 comprises surface condition data 263 for the confined off-road area 1, and the processing circuitry 110 is further configured to: determine the drivable area data 325 based on the weight data 213 and the surface condition data 263; wherein the processing circuitry 110 is configured to: determine the permitted routing trajectories 335 further based on a weigh profile 338 for the specific vehicle 10, 20, 30 for traveling to/from the loading location 231 and/or the unloading location 233, wherein the weight profile 338 is determined based on the weight data 213 of the specific vehicle 10, 20, 30 and the load weight data 235; wherein the vehicle data 210 further comprises a traction capability 215 of the specific vehicle 10, 20, 30, the map data 260 comprises obstacle data 265 indicating one or more obstacles 5 of the confined off-road data 1, and the processing circuitry 110 is further configured to: determine the drivable area data 325 further based on the obstacle data 265 and the traction capability 215 of the specific vehicle 10, 20, 30; herein the traction capability 215 comprises one or more of a wheel base, a ground clearance, traction functionality or an available drive torque of the specific vehicle 10, 20, 30; wherein the vehicle data 210 further comprises travel data 217 of the specific vehicle 10, 20, 30, and the processing circuitry 110 is further configured to: determine the drivable area data 325 further based on the travel data 217 of the specific vehicle 10, 20, 30; herein the travel data 217 indicate at least one of a maximum speed, a minimum speed or a preferred travel speed; wherein the processing circuitry 110 is further configured to: obtain an indication of an update of the vehicle data 210 and/or the map data 260; determine updated drivable area data 325′ for the specific vehicle 10, 20, 30 within the confined off-road area 1 based on updated vehicle data and/or updated map data; and provide the updated drivable area data 325′ for routing of the specific vehicle 10, 20, 30 within the confined off-road area 1; wherein the processing circuitry 110 is further configured to: obtain an indication of an update of the mission data 210; and determine one or more updated permitted routing trajectories 335′ for the specific vehicle 10, 20, 30 to travel to/from the loading location 231 and/or an unloading location 233 based on the drivable area data 325 and the updated mission data; wherein the processing circuitry 110 is further configured to: obtain an indication of a proposed change of the map data 260; and determine proposed drivable area data 325″ for the specific vehicle 10, 20, 30 within the confined off-road area 1 based on the proposed updated map data 325″; and provide the proposed drivable area data 325″ and the drivable area data 325 as decision data for determining if the confined off-road area 1 is to be modified in line with the proposed change of the map data 260 or not; wherein the map data 260 comprises obstacle data 265 indicating one or more obstacles 5 of the confined off-road data 1 and the proposed change of the map data 260 comprises modification of at least one obstacle 5.

Example 16. A site management system 200 for a confined off-road area 1 comprising the computer system on any one of examples 1 to 15.

Example 17. The site management system 200 of example 16, wherein the off-road area 1 is a quarry or a mine.

Example 18. A computer implemented method 400 comprising: obtaining 410, by processing circuitry 110 of a computer system 100, vehicle data 210 of a specific vehicle 10, 20, 30; obtaining 420, by processing circuitry 110 of the computer system 100, map data 260 of a confined off-road area 1; determining, 430, by processing circuitry 110 of the computer system 100, drivable area data 325 for the specific vehicle 10, 20, 30 within the confined off-road area 1 based on the vehicle data 210 and the map data 260; and providing 440, by processing circuitry 110 of the computer system 100, the drivable area data 325 for routing of the specific vehicle 10, 20, 30 within the confined off-road area 1.

Example 19. A computer program product 500 comprising program code 610 for performing, when executed by processing circuitry 110, the computer implemented method 400 of example 18.

Example 20. A non-transitory computer-readable storage medium 700 comprising instructions, which when executed by processing circuitry 110, cause the processing circuitry 110 to perform the computer implemented method 400 of example 18.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
obtain vehicle data of a specific vehicle;
obtain map data of a confined off-road area;
determine drivable area data for the specific vehicle within the confined off-road area based on the vehicle data and the map data; and
provide the drivable area data for routing of the specific vehicle within the confined off-road area.

2. The computer system of claim 1, wherein the processing circuitry is further configured to:
obtain mission data for the specific vehicle, the mission data comprising an indication of a loading location and/or an unloading location within the confined off road area;
determine one or more permitted routing trajectories for the specific vehicle to travel to/from the loading location and/or an unloading location based on the drivable area data and the mission data; and
select one of the one or more permitted routing trajectories as a routing trajectory for routing of the specific vehicle.

3. The computer system of claim 2, wherein the processing circuitry is configured to:
select the routing trajectory based on an energy consumption indicator and/or a vehicle component wear indicator for the specific vehicle to complete the permitted routing trajectories.

4. The computer system of claim 2, wherein the mission data further comprises load weight data indicating a weight of goods to be loaded at the loading location and/or unloaded at the unloading location.

5. The computer system of claim 1, wherein the vehicle data comprises weight data for the specific vehicle, the map data comprises surface condition data for the confined off-road area, and the processing circuitry is further configured to:
determine the drivable area data based on the weight data and the surface condition data.

6. The computer system of claim 4, wherein the processing circuitry is configured to:
determine the permitted routing trajectories further based on a weigh profile for the specific vehicle for traveling to/from the loading location and/or the unloading location, wherein the weight profile is determined based on the weight data of the specific vehicle and the load weight data.

7. The computer system of claim 1, wherein the vehicle data further comprises a traction capability of the specific vehicle, the map data comprises obstacle data indicating one or more obstacles of the confined off-road data, and the processing circuitry is further configured to:
determine the drivable area data further based on the obstacle data and the traction capability of the specific vehicle.

8. The computer system of claim 7, wherein the traction capability comprises one or more of a wheel base, a ground clearance, traction functionality or an available drive torque of the specific vehicle.

9. The computer system of claim 1, wherein the vehicle data further comprises travel data of the specific vehicle, and the processing circuitry is further configured to: determine the drivable area data further based on the travel data of the specific vehicle.

10. The computer system of claim 9, wherein the travel data indicate at least one of a maximum speed, a minimum speed or a preferred travel speed.

11. The computer system of claim 1, wherein the processing circuitry is further configured to: obtain an indication of an update of the vehicle data and/or the map data; determine updated drivable area data for the specific vehicle within the confined off-road area based on updated vehicle data and/or updated map data; and provide the updated drivable area data for routing of the specific vehicle within the confined off-road area.

12. The computer system of claim 2, wherein the processing circuitry is further configured to: obtain an indication of an update of the mission data; and determine one or more updated permitted routing trajectories for the specific vehicle to travel to/from the loading location and/or an unloading location based on the drivable area data and the updated mission data.

13. The computer system of claim 1, wherein the processing circuitry is further configured to:
obtain an indication of a proposed change of the map data; and
determine proposed drivable area data for the specific vehicle within the confined off-road area based on the proposed updated map data; and
provide the proposed drivable area data and the drivable area data as decision data for determining if the confined off-road area is to be modified in line with the proposed change of the map data or not.

14. The computer system of claim 13, wherein the map data comprises obstacle data indicating one or more obstacles of the confined off-road data and the proposed change of the map data comprises modification of at least one obstacle.

15. The computer system of claim 1, wherein the processing circuitry is further configured to: obtain mission data for the specific vehicle, the mission data comprising an indication of a loading location and/or an unloading location within the confined off road area; determine one or more permitted routing trajectories for the specific vehicle to travel to/from the loading location and/or an unloading location based on the drivable area data and the mission data; and select one of the one or more permitted routing trajectories as a routing trajectory for routing of the specific vehicle; wherein the processing circuitry is configured to: select the routing trajectory based on an energy consumption indicator and/or a vehicle component wear indicator for the specific vehicle to complete the permitted routing trajectories; wherein the mission data further comprises load weight data indicating a weight of goods to be loaded at the loading location and/or unloaded at the unloading location; wherein the vehicle data comprises weight data for the specific vehicle, the map data comprises surface condition data for the confined off-road area, and the processing circuitry is further configured to: determine the drivable area data based on the weight data and the surface condition data; wherein the processing circuitry is configured to: determine the permitted routing trajectories further based on a weigh profile for the specific vehicle for traveling to/from the loading location and/or the unloading location, wherein the weight profile is determined based on the weight data of the specific vehicle and the load weight data; wherein the vehicle data further comprises a traction capability of the specific vehicle, the map data comprises obstacle data indicating one or more obstacles of the confined off-road data, and the processing circuitry is further configured to: determine the drivable area data further based on the obstacle data and the traction capability of the specific vehicle; wherein the traction capability comprises one or more of a wheel base, a ground clearance, traction functionality or an available drive torque of the specific vehicle; wherein the processing circuitry is further configured to: obtain an indication of a proposed change of the map data; and determine proposed drivable area data for the specific vehicle within the confined off-road area based on the proposed updated map data; and provide the proposed drivable area data and the drivable area data as decision data for determining if the confined off-road area is to be modified in line with the proposed change of the map data or not; wherein the map data comprises obstacle data indicating one or more obstacles of the confined off-road data and the proposed change of the map data comprises modification of at least one obstacle; wherein the off-road area is a quarry or a mine.

16. A site management system for a confined off-road area comprising the computer system of claim 1.

17. The site management system of claim 16, wherein the off-road area is a quarry or a mine.

18. A computer implemented method comprising:
obtaining, by processing circuitry of a computer system, vehicle data of a specific vehicle;
obtaining, by processing circuitry of the computer system, map data of a confined off-road area;
determining, by processing circuitry of the computer system, drivable area data for the specific vehicle within the confined off-road area based on the vehicle data and the map data; and
providing, by processing circuitry of the computer system, the drivable area data for routing of the specific vehicle within the confined off-road area.

19. A computer program product comprising program code for performing, when executed by processing circuitry, the computer implemented method of claim 18.

20. A non-transitory computer-readable storage medium comprising instructions, which when executed by processing circuitry, cause the processing circuitry to perform the computer implemented method of claim 18.
